(19) United States
(12) Patent Application Publication
(10) Pub. No.: US 2005/0153658 A1
(43) Pub. Date: Jul. 14, 2005

(54) Multiplexed self-structuring antenna system

(76) Inventor: Louis L. Nagy, Warren, MI (US)

Correspondence Address: STEFAN V. CHMIELEWSKI;DELPHI TECHNOLOGIES, INC., Legal Staff MC CT10C, P.O. Box 9005, Kokomo, IN, 46904-9005, US

(21) Appl. No.: 10/755,814

(22) Filed: Jan. 12, 2004

(51) Int. Cl. H04B 1/00

(52) U.S. Cl. 455/63.4; 455/25

(57) ABSTRACT

A communication system incorporates a self-structuring antenna (SSA) system coupled to multiple communication devices, such as receivers, in a multiplexed arrangement. One of the communication devices is employed in a search process to select an antenna configuration suitable for another of the communication devices. The SSA system controls and coordinates the search process for the communication devices. For example, the SSA system resolves conflicts between communication devices when multiple communication devices attempt to access the SSA system simultaneously. Using multiple communication devices, one of which is employed in a search process related to another communication device, may reduce the duration for which communication services are interrupted.

### TECHNICAL FIELD

This disclosure relates generally to communication services. More particularly, this disclosure relates to self-structuring antenna systems.

### BACKGROUND OF THE DISCLOSURE

The vast majority of vehicles currently in use incorporate vehicle communication systems for receiving or transmitting signals. For example, vehicle audio systems provide information and entertainment to many motorists daily. These audio systems typically include an AM/FM radio receiver that receives radio frequency (RF) signals. These RF signals are then processed and rendered as audio output. A vehicle communication system may incorporate other functions, including, but not limited to, wireless data and voice communications, global positioning system (GPS) functionality, satellite-based digital audio radio (SDAR) services. The vehicle communication system may also incorporate remote function access (RFA) capabilities, such as keyless entry, remote vehicle starting, seat adjustment, and mirror adjustment.

Communication systems, including vehicle communication systems, typically employ antenna systems including one or more antennas to receive or transmit electromagnetic radiated signals. In general, such antenna systems have predetermined patterns and frequency characteristics. These predetermined characteristics are selected in view of various factors, including, for example, the ideal antenna RF design, physical antenna structure limitations, and mobile environment requirements. Because these factors often compete with each other, the resulting antenna design typically reflects a compromise. For example, an antenna system for use in an automobile or other vehicle preferably operates effectively over several frequency bands (e.g., AM radio, FM radio, television, remote function access (RFA), wireless data and voice communications, GPS, and SDARS), has distinctive narrowband and broadband frequency characteristics and distinctive antenna pattern characteristics within each such band. Such an antenna system also preferably is capable of operating effectively in view of the structure of the vehicle body (i.e., a large conducting structure with several aperture openings). The operating characteristics, e.g., transmit and receive characteristics, of such an antenna system preferably are independent of the vehicle body style and of vehicle orientation and weather conditions. To accommodate these design considerations, a conventional vehicle antenna system can use several independent antenna systems and still only marginally satisfy basic design specifications.

Significant improvement in mobile antenna performance can be achieved using an antenna that can alter its RF characteristics in response to changing electrical and physical conditions. One type of antenna system that has been proposed to achieve this objective is known as a self-structuring antenna (SSA) system. An example of a conventional SSA system is disclosed in U.S. Pat. No. 6,175,723, entitled “SELF-STRUCTURING ANTENNA SYSTEM WITH A SWITCHABLE ANTENNA ARRAY AND AN OPTIMIZING CONTROLLER,” issued on Jan. 16, 2001 to Rothwell III, and assigned to the Board of Trustees operating Michigan State University (“the '723 patent”). The SSA system disclosed in the '723 patent employs antenna elements that can be electrically connected to one another via a series of switches to adjust the RF characteristics of the SSA system as a function of the communication application or applications and the operating environment. A feedback signal provides an indication of antenna performance and is provided to a control system, such as a microcontroller or microcomputer, that selectively opens and closes the switches. The control system is programmed to selectively open and close the switches in such a way as to improve antenna optimization and performance.

Conventional SSA systems may employ several switches in a multitude of possible configurations or states. For example, an SSA system that has 24 switches, each of which can be placed in an open state or a closed state, can assume any of 16,777,216 (2²⁴) configurations or states. Assuming that selecting a potential switch state, setting the selected switch state, and evaluating the performance of the SSA using the set switch state each take 1 ms, the total time to investigate all 16,777,216 configurations to select an optimal configuration is 50,331.6 seconds, or approximately 13.98 hours. During this time, the SSA system loses acceptable signal reception.

The search time associated with selecting a switch configuration may be improved by limiting the number of configurations that may be selected. For example, if the control system only evaluates 0.001% of the possible switch configurations, the search time can be reduced to slightly less than a second. Laboratory experiments have demonstrated that search times can be made significantly shorter. Nevertheless, the loss of acceptable signal reception every time an SSA system is tuned to a new station, channel, or band is still a significant problem.

### SUMMARY OF VARIOUS EMBODIMENTS

According to various example embodiments, a communication system incorporates a self-structuring antenna (SSA) system coupled to multiple communication devices, such as receivers, in a multiplexed arrangement. One of the communication devices is employed in a search process to select an antenna configuration suitable for another of the communication devices. The SSA system controls and coordinates the search process for the communication devices. For example, the SSA system resolves conflicts between communication devices when multiple communication devices attempt to access the SSA system simultaneously.

One embodiment is directed to a self-structuring antenna system that includes an antenna arrangement having a plurality of antenna elements and a plurality of switching elements arranged with the antenna elements. When the switching elements are selectively closed, selected ones of the antenna elements are electrically coupled to one another to generate an antenna configuration selected from a plurality of antenna configurations. A control arrangement is operatively coupled to the plurality of switching elements and to a plurality of communication devices. The control arrangement is configured to select one of the communication devices to evaluate the selected antenna configuration. The control arrangement is also configured to operatively couple the selected communication device to the antenna arrangement and to close selected ones of the switching elements as a function of the selected antenna configuration. The control arrangement receives a feedback signal from the selected communication device.

In another embodiment, a communication system includes a plurality of communication devices and a processor arrangement operatively coupled to the plurality of communication devices. The processor arrangement is configured to select an antenna configuration from a plurality of antenna configurations and select one of the plurality of communication devices to evaluate the selected antenna configuration. A switch controller is operatively coupled to the processor arrangement and is configured to generate switch control signals as a function of the selected antenna configuration. An antenna arrangement includes a plurality of antenna elements and a plurality of switching elements arranged with the antenna elements. When the switching elements are selectively closed in response to the switch control signals, selected ones of the antenna elements are electrically coupled to one another to generate the selected antenna configuration. A multiplexing subsystem is operatively coupled to the plurality of communication devices and to the antenna arrangement. The multiplexing subsystem is configured to operatively couple the selected one of the communication devices to the antenna arrangement.

Another embodiment is directed to a method of configuring an antenna system that includes a plurality of antenna elements. An antenna configuration is selected from a plurality of antenna configurations. One of a plurality of communication devices is selected to evaluate the selected antenna configuration. The selected communication device is operatively coupled to the antenna system. A plurality of switching elements are configured as a function of the selected antenna configuration to electrically couple selected ones of the plurality of antenna elements to one another, thereby generating the selected antenna configuration. A feedback signal is received from the selected communication device. This method may be embodied in a processor-readable medium storing processor-executable instructions.

Various embodiments may provide certain advantages. For instance, using multiple communication devices, one of which is employed in a search process related to another communication device, may reduce the duration for which communication services are interrupted.

Additional objects, advantages, and features will become apparent from the following description and the claims that follow, considered in conjunction with the accompanying drawings.

### BRIEF DESCRIPTION OF THE DRAWINGS

FIG. 1 is a block diagram illustrating an example self-structuring antenna system according to an embodiment.

FIG. 2 is a block diagram illustrating an example communication system according to another embodiment.

FIG. 3 is a flow diagram illustrating an example method to configure an antenna system according to yet another embodiment.

### DESCRIPTION OF VARIOUS EMBODIMENTS

A communication system incorporates a self-structuring antenna (SSA) system coupled to multiple receivers or other communication devices in a multiplexed arrangement. One of the communication devices is employed in a search process to select an antenna configuration suitable for another of the communication devices. The SSA system controls and coordinates the search process for the communication devices. For example, the SSA system resolves conflicts between communication devices when multiple communication devices attempt to access the SSA system simultaneously. Using multiple communication devices enables the SSA system to evaluate antenna configurations as a background operation; that is, using one communication device to evaluate antenna configurations while using another communication device to provide communication services. As a result, the SSA system can reduce the duration for which communication services are interrupted.

In the following description, numerous specific details are set forth in order to provide a thorough understanding of various embodiments of the present invention. It will be apparent to one skilled in the art that the present invention may be practiced without some or all of these specific details. In other instances, well known components and process steps have not been described in detail in order to avoid unnecessarily obscuring the present invention.

Some embodiments may be described in the general context of processor-executable instructions, such as program modules, being executed by a processor. Generally, program modules include routines, programs, objects, components, data structures, etc., that perform particular tasks or implement particular abstract data types.

Referring now to the drawings, FIG. 1 illustrates an example antenna system 100 according to one embodiment. An antenna 102 is formed by antenna elements 104 that are arranged with switching elements 106 in a pattern, such as the example pattern depicted in FIG. 1. Those skilled in the art will appreciate that the antenna elements 104 and the switching elements 106 can be arranged in patterns other than the example pattern depicted in FIG. 1. Such patterns can be designed for acceptable performance under certain operating conditions. The antenna elements 104, indicated by solid line segments in FIG. 1, can be implemented by wires or other conductors, including but not limited to conductive traces. Patches or other radiating devices may also be used to implement one or more of the antenna elements 104. The switching elements 106, indicated by rectangles in FIG. 1, are controllable to be placed in an open state or a closed state via application of an appropriate control voltage or control signal. The switching elements 106 may be implemented using bipolar junction transistors (BJTs) controlled by applying an appropriate base voltage. Alternatively, the switching elements 106 may be implemented using field-effect transistors (FETs) controlled by applying an appropriate gate voltage. The switching elements 106 may also be implemented using a combination of BJTs and FETs and possibly other devices well-known to those of ordinary skill in the art, including more complex devices, such as integrated circuits (ICs). As another alternative, the switching elements 106 can be implemented using mechanical devices, such as relays or miniature electromechanical system (MEMS) switches. For purposes of clarity, control terminals and control lines connected to individual switching elements 106 are not illustrated.

Closing a switching element 106 establishes an electrical connection between any antenna elements 104 to which the switching element 106 is connected. Opening a switching element 106 disconnects the antenna elements 104 to which the switching element 106 is connected. Accordingly, by closing some switching elements 106 and opening other switching elements 106, various antenna elements 104 can be selectively electrically connected to form different configurations. Selecting which switching elements 106 are closed enables the antenna system 100 to implement a wide variety of different antenna shapes, including but not limited to loops, dipoles, stubs, etc. The antenna elements 104 need not be electrically connected to other antenna elements 104 to affect the performance of the antenna system 100. Rather, each antenna element 104 forms part of the antenna system 100 regardless of whether the antenna element 104 is electrically connected to adjacent antenna elements 104.

A control arrangement 108 selects particular switching elements 106 to be opened or closed to form a selected antenna configuration. The control arrangement 108 is operatively coupled to the switching elements 106 via control lines, e.g., a control bus 110. The control arrangement 108 may incorporate, for example, a processor and a switch control module.

To select particular switching elements 106 to be opened or closed, the control arrangement 108 selects an antenna configuration. When the antenna system 100 is first activated, the control arrangement 108 searches the conceptual space of possible antenna configurations to identify an antenna configuration that will produce acceptable antenna performance under the prevailing operating conditions. The control arrangement 108 may select the antenna configuration based on a communication band in which the antenna system 100 is operating. For example, the control arrangement 108 may select the antenna configuration based on whether the antenna system 100 is operating in a communication band designated for AM radio, FM radio, television, remote function access (RFA), wireless data and voice communications, global positioning system (GPS), or satellite-based digital audio radio services (SDARS).

To increase the speed of the search process, an optional memory 112 stores antenna configurations, e.g., switch states, that are expected to produce acceptable antenna performance. It will be appreciated by those of skill in the art that the search process may be performed without the use of the memory 112. Including the memory 112, however, is advantageous in that information gained from previous iterations of the search process can be used to improve the efficiency of subsequent iterations of the search process.

The memory 112, if present, is operatively coupled to the control arrangement 108, for example, via an address bus 114 and a data bus 116. The memory 112 may be implemented using any of a variety of conventional memory devices, including, but not limited to, random access memory (RAM) devices, static random access memory (SRAM) devices, dynamic random access memory (DRAM) devices, non-volatile random access memory (NVRAM) devices, and non-volatile programmable memories, such as programmable read only memory (PROM) devices and EEPROM devices. The memory 112 may also be implemented using a magnetic disk device or other data storage medium.

The memory 112 can store the antenna configurations or switch states using any of a variety of representations. In some embodiments, each switching element 106 may be represented by a bit having a value of 1 if the switching element 106 is open or a value of 0 if the switching element 106 is closed in a particular antenna configuration. Accordingly, each antenna configuration is stored as a binary word having a number of bits equal to the number of switching elements 106 in the antenna system 100. The example antenna system 100 illustrated in FIG. 1 includes seventeen switching elements 106. Therefore, in such embodiments, each antenna configuration would be represented as a 17-bit binary word.

In some embodiments, multiple switching elements 106 may be controlled to assume the same open or closed state as a group. For example, as the antenna system 100 develops usage history, the control arrangement 108 may determine that performance benefits may result when certain groups of antenna elements 104 are electrically connected or disconnected. Alternatively, the determination to control such switching elements 106 as a group may be made at the time of manufacture of the antenna system 100. For example, certain zones formed by groups of antenna elements 104 may be controlled as a group for different frequency bands. When multiple switching elements 106 are controlled as a group, smaller binary words can represent antenna configurations or switch states. This more compact representation may yield certain benefits, particularly when the determination to control switching elements 106 as a group is made at the time of manufacture. In this case, the memory 112 may be implemented using a device having less storage capacity, potentially resulting in decreased manufacturing costs.

As the antenna system 100 is used, the control arrangement 108 updates the memory 112 to improve subsequent iterations of the search process. The control arrangement 108 causes the memory 112 to store binary words that represent the switch states for antenna configurations that are determined to produce acceptable antenna characteristics. Accordingly, when the control arrangement 108 repeats the search process, e.g., when the antenna system 100 is reactivated after having been deactivated, the search process can begin at an antenna configuration that is known to produce acceptable results. In conventional antenna systems lacking a memory 112, historical information is lost after each iteration of the search process, for example, every time the communication system is turned off or tuned to a different communication band. In such conventional antenna systems, the search process begins anew with each iteration. By contrast, storing and using historical information relating to previous iterations of the search process can improve the speed of the search process.

In the embodiment illustrated in FIG. 1, the antenna system 100 is operatively coupled to communication devices 118a-118n, collectively identified as communication devices 118, via control lines, such as an RF cable. For example, if the antenna system 100 is located in a vehicle having multiple communication devices 118, the communication devices 118 may be operatively coupled to the antenna system 100 via a high-speed data bus 120. The communication devices 118 may include, e.g., one or more receivers in combination with one or more transmitters. In addition, the communication devices 118 may include one or more devices having both transmitting and receiving capabilities.

In operation, when the antenna system 100 is first activated or switched to a different communication band or frequency, the control arrangement 108 initiates the search process to select an antenna configuration. The control arrangement 108 then addresses the memory 112 via the address bus 114 to access the binary word stored in the memory 112 that corresponds to the selected antenna configuration. The control arrangement 108 receives the binary word via the data bus 116 and, based on the binary word, outputs appropriate switch control signals to the switching elements 106 via the control bus 110. The switch control signals selectively open or close the switching elements 106 as appropriate. As a result, appropriate antenna elements 104 are electrically connected or disconnected to form the selected antenna configuration.

The control arrangement 108 selects one such communication device 118 to evaluate the selected antenna configuration. To evaluate the selected antenna configuration, the control arrangement 108 operatively couples the selected communication device 118 to the antenna 102. When the selected communication device 118 is operatively coupled to the antenna 102, the selected communication device 118 generates a feedback signal. The feedback signal may indicate certain strength or directional characteristics of the radiated electromagnetic signal. For example, the selected communication device 118 may provide a received signal strength indicator (RSSI) signal. Alternatively, the feedback signal may indicate the impedance of the antenna 102, e.g., for use in impedance matching. As another alternative, a remote communication device, such as a remote receiver other than the selected communication device 118, may generate the feedback signal. By altering the configuration of the antenna 102 in response to a feedback signal generated by a remote receiver, reception at the remote receiver may be improved. In addition, the control arrangement 108 may update the memory 112 in response to the feedback signal. For example, if the feedback signal indicates that a particular antenna configuration produces better antenna characteristics than a previously-stored default antenna configuration, the control arrangement 108 may update the memory 112 to replace the previously-stored default antenna configuration with the antenna configuration producing better antenna characteristics.

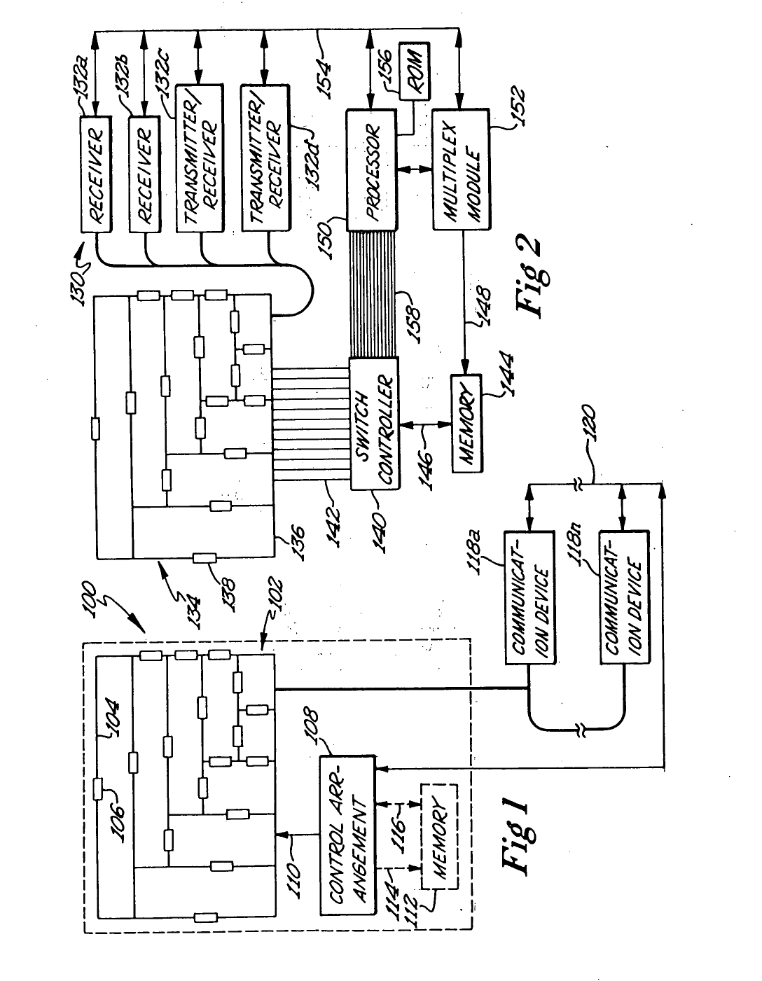

FIG. 2 is a block diagram illustrating an example communication system 130 according to another embodiment. While not required, the communication system 130 may be installed in an automobile or other vehicle. Alternatively, the communication system 130 may be implemented as a standalone unit, e.g., a portable entertainment system. The communication system 130 includes communication devices 132a, 132b, 132c, and 132d, collectively identified as communication devices 132. As illustrated in FIG. 2, the communication devices 132a and 132b are receivers configured to receive a radiated electromagnetic signal, such as an RF signal, via an antenna 134. The communication devices 132c and 132d are capable of both receiving and transmitting radiated electromagnetic signals using the antenna 134. Depending on the particular application, the radiated electromagnetic signal can be of any of a variety of types, including but not limited to an AM or FM radio signal; a UHF or VHF television signal; an RFA signal; a CDMA, GSM, or other wireless data and voice communications signal; a GPS signal; or an SDARS signal. Those skilled in the art will appreciate that the configuration shown in FIG. 2 is merely illustrative, and that other combinations of communication devices 132 may be employed. For example, rather than multiple communication devices 132, some implementations of the communication system 130 may incorporate a single broadband communication device.

The antenna 134 includes antenna elements 136 that are arranged to receive or transmit the radiated electromagnetic signal. The antenna elements 136 are arranged with switching elements 138 in a pattern, such as the example pattern depicted in FIG. 2. Patterns other than the example pattern illustrated in FIG. 2 may be formed by the arrangement of the antenna elements 136 and the switching elements 138. Such alternative patterns can be designed for acceptable performance under certain operating conditions. The antenna elements 136, indicated by solid line segments in FIG. 2, can be implemented by wires or other conductors, including but not limited to conductive traces. Patches or other radiating devices may also be used to implement one or more of the antenna elements 136. The switching elements 138, indicated by rectangles in FIG. 2, can be placed in an open state or a closed state via application of an appropriate control voltage or control signal. The switching elements 138 may be implemented using bipolar junction transistors (BJTs), field-effect transistors (FETs), or a combination of BJTs and FETs and possibly other devices, such as integrated circuits (ICs). As another alternative, the switching elements 138 can be implemented using relays or other mechanical devices. For purposes of clarity, control terminals and control lines connected to individual switching elements 138 are not illustrated.

The antenna elements 136 can be electrically connected to or disconnected from one another by closing or opening appropriate switching elements 138. In this way, the antenna 134 can implement a wide variety of different antenna configurations, including but not limited to loops, dipoles, stubs, etc. The antenna elements 136 need not be electrically connected to other antenna elements 136 to affect the performance of the antenna 134. Rather, each antenna element 136 forms part of the antenna 134 regardless of whether the antenna element 136 is electrically connected to adjacent antenna elements 136.

A switch controller 140 provides control signals to the switching elements 138 to selectively open or close the switching elements 138 to implement particular antenna configurations. The switch controller 140 is operatively coupled to the switching elements 138 via control lines 142.

The switch controller 140 is also operatively coupled to a memory 144, for example, via a bus 146. The memory 144 stores antenna configurations or switch states and is addressable using the bus 146 or lines 148. It should be noted that the memory 144 need not store all possible antenna configurations or switch states. For many applications, it would be sufficient for the memory 144 to store up to a few hundred of the possible antenna configurations or switch states. Accordingly, any of a variety of conventional memory devices may implement the memory 144, including, but not limited to, RAM devices, SRAM devices, DRAM devices, NVRAM devices, and non-volatile programmable memories, such as PROM devices and EEPROM devices. The memory 144 may also be implemented using a magnetic disk device or other data storage medium.

The memory 144 can store the antenna configurations or switch states using any of a variety of representations. In some embodiments, each switching element 138 may be represented by a bit having a value of 1 if the switching element 138 is open or a value of 0 if the switching element 138 is closed in a particular antenna configuration. Accordingly, each antenna configuration is stored as a binary word having a number of bits equal to the number of switching elements 138 in the antenna 134. The example antenna 134 illustrated in FIG. 2 includes seventeen switching elements 138. Therefore, in such embodiments, each antenna configuration would be represented as a 17-bit binary word. As described above in connection with FIG. 1, a single bit can represent groups of multiple switching elements 138 that are consistently controlled as a unit.

In operation, a processor 150 selects an antenna configuration appropriate to the operational state of the communication system 130, e.g., a frequency or communication band in which the communication system 130 is operating. For example, the processor 150 may select the antenna configuration based on whether the antenna 134 is to be configured to receive an AM or FM radio signal; a UHF or VHF television signal; a remote function access (RFA) signal; a CDMA, GSM, or other wireless data and voice communications signal; a global positioning system (GPS) signal; or a satellite-based digital audio radio services (SDARS) signal.

The processor 150 also selects one of the communication devices 132 and provides a selection signal to a multiplexer 152, which is operatively coupled to the communication devices 132 via, e.g., a high-speed data bus 154 and to the antenna 134. The multiplexer 152 can be implemented using any of a variety of multiplexing arrangements that are known in the art. Multiplexing may also be implemented using switches external to the communication devices 132 to selectively isolate the communication devices 132 from the antenna 134 or by programming the communication devices 132 to be selectively nonresponsive to the antenna 134. Either of these techniques may be used independently or in conjunction with the multiplexer 152. In response to the selection signal, the multiplexer 152 operatively couples the selected communication device 132 to the antenna 134.

The processor 150 then initiates a search process of the conceptual space of possible antenna configurations to select an appropriate antenna configuration. In some embodiments, rather than beginning at a randomly selected antenna configuration each time the search process is initiated, the processor 150 starts the search process at a switch configuration that is known to have produced acceptable antenna characteristics under the prevailing operating conditions at some point during the usage history of the communication system 130. For example, the processor 150 may address the memory 144 to retrieve a default switch configuration for a given communication band. If the default configuration produces acceptable antenna characteristics, the processor 150 uses the default switch configuration. On the other hand, if the default switch configuration no longer produces acceptable antenna characteristics, the processor 150 searches for a new switch configuration using the default switch configuration as a starting point.

Regardless of whether the processor 150 selects the default switch configuration or another switch configuration, the processor 150 indicates the selected switch configuration to the switch controller 140 via lines 158. The switch controller 140 then addresses the memory 144 via the bus 146 to access the binary word stored in the memory 144 that corresponds to the selected antenna configuration. The switch controller 140 receives the binary word via the bus 146 and, based on the binary word, outputs appropriate switch control signals to the switching elements 138 via the control lines 142. The switch control signals selectively open or close the switching elements 138 as appropriate, thereby forming the selected antenna configuration.

As part of the search process, the processor 150 then evaluates the selected antenna configuration using the selected communication device 132. To evaluate the selected antenna configuration, the selected communication device 132 generates a feedback signal when it is operatively coupled to the antenna 134. The feedback signal may indicate certain strength or directional characteristics of the radiated electromagnetic signal received or transmitted by the antenna 134. For example, the selected communication device 132 may provide a received signal strength indicator (RSSI) signal. Alternatively, the feedback signal may indicate the impedance of the antenna 134, e.g., for use in impedance matching. As another alternative, a remote communication device, such as a remote receiver other than the selected communication device 132, may generate the feedback signal. By altering the configuration of the antenna 134 in response to a feedback signal generated by a remote receiver, reception at the remote receiver may be improved. In addition, the switch controller 140 may update the memory 144 in response to the feedback signal. For example, if the feedback signal indicates that a particular antenna configuration produces better antenna characteristics than a previously-stored default antenna configuration, the switch controller 140 may update the memory 144 to replace the previously-stored default antenna configuration with the antenna configuration producing better antenna characteristics.

Because the communication system 130 incorporates multiple communication devices 132, the processor 150 can use the selected communication device 132 to evaluate the selected antenna configuration while another communication device 132 provides communication services to the user. For example, if the processor 150 selects the communication device 132d for evaluating the selected antenna configuration, the communication device 132a can continue to provide communication services to the user. Accordingly, the process of searching for a suitable antenna configuration that produces acceptable results can be performed as a background operation, thereby reducing or eliminating the interruption in communication services during the search process. In addition, the communication device 132 can provide multiple communication services to the user. The processor 150 and the multiplexer 152 assigns priorities to and resolves conflicts between multiple communication services. If these services are integrated into a single physical package, such a package can incorporate the communication devices 132 and the other components of the communication system 130.

The processor 150 is typically configured to operate with one or more types of processor readable media, such as a read-only memory (ROM) device 156. Processor readable media can be any available media that can be accessed by the processor 150 and includes both volatile and nonvolatile media, removable and non-removable media. By way of example, and not limitation, processor readable media may include storage media and communication media. Storage media includes both volatile and nonvolatile, removable and nonremovable media implemented in any method or technology for storage of information such as processor-readable instructions, data structures, program modules, or other data. Storage media includes, but is not limited to, RAM, ROM, EEPROM, flash memory or other memory technology, CD-ROM, digital versatile discs (DVDs) or other optical disc storage, magnetic cassettes, magnetic tape, magnetic disk storage or other magnetic storage devices, or any other medium that can be used to store the desired information and that can be accessed by the processor 150. Communication media typically embodies processor-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.. Combinations of any of the above are also intended to be included within the scope of processor-readable media.

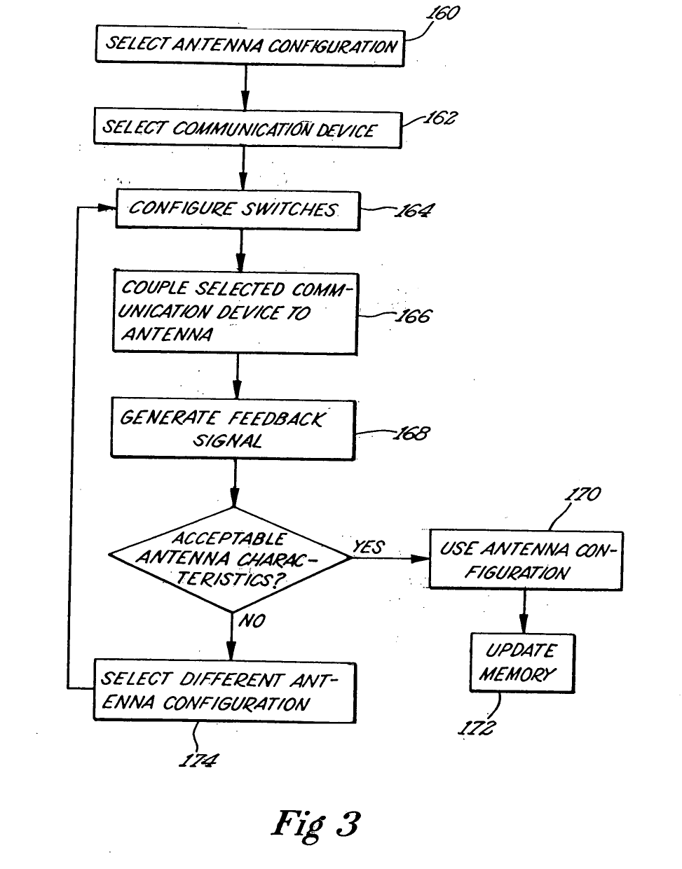

FIG. 3 is a flow diagram illustrating an example method for configuring the antenna 134. The method may be performed, for example, in accordance with processor-readable instructions stored in the ROM 154 of FIG. 2. First, the processor 150 selects a preliminary antenna configuration (160). This preliminary selection may be performed, for example, based on the communication band in which the antenna 134 is operating. In some embodiments, the processor 150 accesses the memory 144 to retrieve a default antenna configuration that has produced or is expected to produce acceptable antenna characteristics in the current communication band.

The processor 150 also selects one of the communication devices 132 to evaluate the selected antenna configuration (162). To reduce the interruption in communication services provided to the user, the processor 150 preferably selects a communication device 132 other than a communication device 132 that is currently providing communication services. For example, if the communication device 132a is providing communication services, the processor 150 may select the communication device 132d to evaluate the selected antenna configuration. By selecting a different communication device 132, the processor 150 can configure the antenna 134 as a background operation that is transparent to the user. That is, user perception of the interruption in communication services may be reduced or eliminated.

The processor 150 then configures the switching elements 138 to produce the antenna configuration (164) by controlling the memory 144 to output data representing the antenna configuration. Based on this data, the switch controller 140 drives each switching element 138 to an open state or a closed state, as appropriate. As a result, the appropriate antenna elements 136 are electrically connected or disconnected, thereby generating the selected antenna configuration.

Next, the processor 150 evaluates the performance of the selected antenna configuration. The processor 150 outputs a selection signal to the multiplexer 152. In response to the selection signal, the multiplexer 152 operatively couples (166) the selected communication device 132 to the antenna 134.

When the selected communication device 132 is operatively coupled to the antenna 134, the selected communication device 132 generates a feedback signal (168). The feedback signal may indicate certain strength or directional characteristics of the radiated electromagnetic signal received or transmitted by the antenna 134. For example, the selected communication device 132 may provide a received signal strength indicator (RSSI) signal. Alternatively, the feedback signal may indicate the impedance of the antenna 134, e.g., for use in impedance matching. As another alternative, a remote communication device, such as a remote receiver other than the selected communication device 132, may generate the feedback signal. By altering the configuration of the antenna 134 in response to a feedback signal generated by a remote receiver, reception at the remote receiver may be improved.

If the feedback signal indicates that the selected antenna configuration produces acceptable antenna characteristics, the processor 150 uses that antenna configuration (170). While not required, the processor 150 may also update the memory 144 so that the selected antenna configuration is used as a default antenna configuration the next time the communication system is operated in the selected communication band (172).

On the other hand, if the feedback signal indicates that the selected antenna configuration does not produce acceptable antenna characteristics, the processor 150 selects a different antenna configuration (174). The processor 150 then configures the switching elements 138 to produce the newly selected antenna configuration (164) and again evaluates the performance of the antenna configuration.

When the processor 150 identifies an antenna configuration that produces acceptable antenna characteristics, the processor 150 uses that antenna configuration (170). In addition, the processor 150 updates the memory 144 to replace the previously stored antenna configuration with the new antenna configuration (172). In this way, the communication system 130 adapts to changing environmental conditions, as well as changing conditions relating to the antenna 134 itself. For example, as the communication system 130 ages, certain antenna elements 136 or switching elements 138 may exhibit declining performance or stop functioning entirely. Accordingly, certain switch configurations that once produced acceptable antenna characteristics may no longer work as well. By updating the memory 144, such switch configurations can be eliminated from further consideration.

As demonstrated by the foregoing discussion, various embodiments may provide certain advantages. For instance, using one communication device to evaluate antenna characteristics while another communication device provides communication services allows the process of searching for a suitable antenna configuration that produces acceptable results to be performed as a background operation. As a result, the interruption in communication services during the search process can be reduced or eliminated. In addition, multiple communication services can be provided to the user.

It will be understood by those skilled in the art that various modifications and improvements may be made without departing from the spirit and scope of the disclosed embodiments. The scope of protection afforded is to be determined solely by the claims and by the breadth of interpretation allowed by law.

1. A self-structuring antenna system comprising:
an antenna arrangement comprising a plurality of antenna elements and a plurality of switching elements arranged with the antenna elements to, when selectively closed, electrically couple selected ones of the antenna elements to one another to generate an antenna configuration selected from a plurality of antenna configurations; and
a control arrangement operatively coupled to the plurality of switching elements and to a plurality of communication devices and configured to
select one of the communication devices to evaluate the selected antenna configuration,
operatively couple the selected one of the communication devices to the antenna arrangement,
close selected ones of the switching elements as a function of the selected antenna configuration, and
receive a feedback signal from the selected one of the communication devices.

2. The self-structuring antenna system of claim 1, further comprising a memory operatively coupled to the control arrangement and configured to store data representing at least some of the plurality of antenna configurations and to selectively update the data as a function of the feedback signal.

3. The self-structuring antenna system of claim 1, wherein the control arrangement is configured to select the antenna configuration from the plurality of antenna configurations in response to the feedback signal.

4. The self-structuring antenna system of claim 1, wherein the feedback signal comprises one of a received signal strength indicator (RSSI) signal, an antenna impedance indicator signal, and a control signal received from a remote receiver.

5. The self-structuring antenna system of claim 1, wherein the control arrangement is configured to select the antenna configuration from the plurality of antenna configurations as a function of a communication band in which the self-structuring antenna system is operating.

6. The self-structuring antenna system of claim 5, wherein the communication band comprises a communication band selected for operation in an operational mode selected from the group consisting of AM radio, FM radio, television, remote function access (RFA), wireless data and voice communications, global positioning system (GPS), and satellite-based digital audio radio services (SDARS).

7. The self-structuring antenna system of claim 1, wherein the control arrangement comprises:
a processor arrangement configured to select the antenna configuration from the plurality of antenna configurations in response to the control signal;
a switch controller operatively coupled to the plurality of switching elements and to the processor arrangement and configured to close the selected ones of the switching elements as a function of the selected antenna configuration; and
a multiplexing subsystem operatively coupled to the processor arrangement, to the antenna arrangement, and to the plurality of communication devices and configured to operatively couple the selected one of the communication devices to the antenna arrangement.

8. The self-structuring antenna system of claim 1, wherein the plurality of communication devices comprises at least one of a receiver and a transmitter.

9. A communication system comprising:
a plurality of communication devices;
a processor arrangement operatively coupled to the plurality of communication devices and configured to
select an antenna configuration from a plurality of antenna configurations, and
select one of the plurality of communication devices to evaluate the selected antenna configuration;
a switch controller operatively coupled to the processor arrangement and configured to generate a plurality of switch control signals as a function of the selected antenna configuration;
an antenna arrangement comprising
a plurality of antenna elements, and
a plurality of switching elements arranged with the antenna elements to, when selectively closed in response to the switch control signals, electrically couple selected ones of the antenna elements to one another to generate the selected antenna configuration; and
a multiplexing subsystem operatively coupled to the plurality of communication devices and to the antenna arrangement and configured to operatively couple the selected one of the communication devices to the antenna arrangement.

10. The communication system of claim 9, wherein the selected one of the plurality of communication devices is configured to generate a feedback signal in response to being operatively coupled to the antenna arrangement.

11. The communication system of claim 10, further comprising further comprising a memory operatively coupled to the control arrangement and configured to:
store data representing at least some of the plurality of antenna configurations; and
selectively update the data as a function of the feedback signal.

12. The communication system of claim 10, wherein the feedback signal comprises-one of a received signal strength indicator (RSSI) signal, an antenna impedance indicator signal, and a control signal received from a remote receiver.

13. The communication system of claim 9, wherein the processor arrangement is configured to select the antenna configuration from the plurality of antenna configurations as a function of a communication band in which the communication system is operating.

14. The communication system of claim 13, wherein the communication band comprises a communication band selected for operation in an operational mode selected from the group consisting of AM radio, FM radio, television, remote function access (RFA), wireless data and voice communications, global positioning system (GPS), and satellite-based digital audio radio services (SDARS).

15. The communication system of claim 9, wherein the plurality of communication devices comprises at least one of a receiver and a transmitter.

16. A method of configuring an antenna system comprising a plurality of antenna elements, the method comprising:
selecting an antenna configuration from a plurality of antenna configurations;
selecting one of a plurality of communication devices to evaluate the selected antenna configuration;
operatively coupling the selected one of the plurality of communication devices to the antenna system;
configuring a plurality of switching elements as a function of the selected antenna configuration to electrically couple selected ones of the plurality of antenna elements to one another, thereby generating the selected antenna configuration; and
receiving a feedback signal from the selected one of the plurality of the communication devices.

17. The method of claim 16, further comprising:
receiving data relating to the selected antenna configuration from a memory; and
updating the data as a function of the feedback signal.

18. The method of claim 15, wherein the feedback signal comprises one of a received signal strength indicator (RSSI) signal, an antenna impedance indicator signal, and a control signal received from a remote receiver.

19. The method of claim 15, further comprising selecting the antenna configuration from the plurality of antenna configurations as a function of a communication band.

20. The method of claim 19, wherein the communication band comprises a communication band selected for operation in an operational mode selected from the group consisting of AM radio, FM radio, television, remote function access (RFA), wireless data and voice communications, global positioning system (GPS), and satellite-based digital audio radio services (SDARS).

21. A processor-readable medium having processor-executable instructions for:
selecting an antenna configuration from a plurality of antenna configurations;
selecting one of a plurality of communication devices to evaluate the selected antenna configuration;
operatively coupling the selected one of the plurality of communication devices to an antenna system comprising a plurality of antenna elements;
configuring a plurality of switching elements as a function of the selected antenna configuration to electrically couple selected ones of the plurality of antenna elements to one another, thereby generating the selected antenna configuration; and
receiving a feedback signal from the selected one of the plurality of the communication devices.

22. The processor-readable medium of claim 21, having further processor-executable instructions for:
receiving data relating to the selected antenna configuration from a memory; and
updating the data as a function of the feedback signal.

23. The processor-readable medium of claim 21, wherein the feedback signal comprises one of a received signal strength indicator (RSSI) signal, an antenna impedance indicator signal, and a control signal received from a remote receiver.

24. The processor-readable medium of claim 21, having further processor-executable instructions for selecting the antenna configuration from the plurality of antenna configurations as a function of a communication band.

25. The processor-readable medium of claim 24, wherein the communication band comprises a communication band selected for operation in an operational mode selected from the group consisting of AM radio, FM radio, television, remote function access (RFA), wireless data and voice communications, global positioning system (GPS), and satellite-based digital audio radio services (SDARS).
